(19) United States
(12) Patent Application Publication
(10) Pub. No.: US 2013/0312329 A1
(43) Pub. Date: Nov. 28, 2013

(54) Combination Ceramic Filter and Filter Cleaning System System for Removing or Converting Undesirable Species from a Biomass Gasfifier Product Gas Stream and Method of Using the Same

(71) Applicant: Industrial Ceramics Solutions, LLC, Oak Ridge, TN (US)

(72) Inventor: Richard D. Nixdorf, Knoxville, TN (US)

(73) Assignee: Industrial Ceramics Solutions, LLC, Oak Ridge, TN (US)

(21) Appl. No.: 13/899,149

(22) Filed: May 21, 2013

Related U.S. Application Data
(60) Provisional application No. 61/650,657, filed on May 23, 2012.

(51) Int. Cl. B01D 46/00

(52) U.S. Cl. CPC B01D 46/006
USPC 48/201; 55/282.3

(57) ABSTRACT

A system and method for removing particulates and carbonaceous contaminates and tars from a continuous gas stream, such as a biomass gasifier syngas stream, generated from a combustible source is disclosed. The system and method may include a mechanical filter assembly having an intake to receive the gas stream, an outlet to exhaust the gas stream, and a ceramic fiber filtration media interposing the intake and outlet to remove particle contaminates and tars from the gas stream. A means for regenerating the mechanical filter assembly using an auxiliary heat source communicably coupled to the mechanical filter assembly is also provided and an air-backpulse to remove inorganic ash.

### CROSS-REFERENCE TO RELATED APPLICATIONS

This application claims the benefit under 35 U.S.C. section 119(e) of U.S. Provisional Patent Application 61/650,657, filed May 23, 2012.

### FIELD OF INVENTION

The present inventive concept relates generally to the filtration of gas streams, and more particularly to a system and method that incorporates biomass syngas products and mechanical filtration, whereby a ceramic fiber filter assembly limits particulates generated by reduced oxygen biomass combustion based on size, volume, and/or velocity. Even more particularly, the present general inventive concept may include the application of auxiliary heat and or a catalyst to clean the assembly in-situ in order to provide continuous operating capabilities to the biomass syngas production system.

### BACKGROUND

Plasma energy and other forms of biomass combustion have generally been known in the art since as early as 1920. Subsequently, plasma energy has been commercialized for use in several applications, including metal welding, metal plasma cutting, and others. As recently as the last decade, use of plasma energy and thermal combustion have been applied to filtration, for instance, to neutralize chemical weapons by destroying harmful gases and to turn solid waste products into disposable gases and solids.

Most recently, the applicability of plasma energy and thermal combustion have been investigated in the biomass power generation industry to burn combustible waste products, such as wood or paper, in a limited oxygen environment to produce a syngas that may then be burned to yield useable heat or to run an internal combustion gas generator to yield electricity. Those of skill in the art will recognize that the burning of organic materials in a limited oxygen environment to produce syngas limits the ability of the syngas components themselves to further combust, thereby preserving their potential as an energy source. One problem with this application, however, is that the hot syngas streams produced are often laden with unburned waste particles, carbon and hydrocarbon particulates, gaseous contaminates, such as tars, which inhibit the thermal energy potential of the syngas or limit its use in a combustion engine generator. Filtration of the gas streams is therefore desirable to remove or change these contaminates which pass through the filter. However, the efficacy of plasma energy and biomass combustion filtration is often limited and/or compromised by the presence of large particle contaminates and/or tar which render the filter blinded and inoperable.

Prior art methods of handling these contaminates have generally fallen into two categories: gas accumulation and cooling prior to filtration. Gas accumulation typically requires very large chambers or vessels for collecting the gas in order expose it to plasma energy for a sufficient duration to allow the plasma to adequately react with all of the contaminates. The high temperature vessels are frequently expensive, and the system often requires high amounts of electrical power to operate. Similarly, gas cooling often requires complex infrastructure and significant amounts of electricity to cool the gas streams ranging from 750-1450 degrees Fahrenheit (° F.) to a temperature of less than 200° F. in order to filter it using a conventional, mechanical filter system. These prior art methods are frequently undesirable due to the significant capital expenses and operating costs required.

A third prior art method for handling contaminates produced from biomass power generation has proven even more ineffective and undesirable. Attempts have been made to install low porosity membrane filters, such as ceramic or sintered metal candle filters, downstream from a plasma energy or biomass thermal combustion source to provide for direct filtration of the hot gas stream. Such filter assemblies are frequently extremely heavy in order to withstand the significant backpressure created by the typically numerous filter elements. Any exposure to tar during start-up, shut-down, or process perturbations will generally coat the filter elements and render them useless, thus requiring their removal for cleaning and/or replacement. Likewise, this prior art method requires significant capital expenditures and operating costs, and does not provide an efficient way to continuously filter the contaminated gas streams.

Thus, there exists a need in the art for a system and method to filter particulate contaminates from a tar-rich continuous hot gas stream at any velocity using a light-weight and/or low backpressure pre-filter assembly located upstream from a contained plasma medium. Eliminating the bulk of the particle contaminates prior to plasma treatment or gas stream cooling obviates the need for large holding chambers and subsequent excessive power input previously required for efficient plasma treatment or the expense of cooling systems, which then require reheating systems for efficient operation of the turbine generator. Moreover, a system and method is needed to permit exposure of the ceramic fiber filter assembly to heat and reverse air-pulsing in order to clean the assembly in-situ, thereby providing continuous operating capabilities to the ceramic fiber filter treatment system.

### BRIEF SUMMARY

In accordance with various example embodiments of the present general inventive concept, a combination mechanical filter and an insitu filter cleaning system may include a mechanical filter assembly, such as ceramic fiber filter cartridges, in a pleated filter form, assembled in an enclosed, gas-tight containment structure with a gas intake. The gas intake is sealed from the gas outlet to force the contaminated gas to pass through the ceramic fiber filtration media before exiting the sealed containment structure. As the gas passes through the ceramic fiber filter media, particles greater than one micrometer in diameter and/or tars are trapped on the filter media. The finer particulates and gases pass through the filter media outlet to the plasma energy chamber or liquid scrubbers for total removal and/or conversion to useful gases. Upon shut-down of the ceramic fiber filter system or diversion to a second filter assembly, the ceramic fiber filter media is exposed to a high temperature air stream in excess of 750° F., generally for one to three hours, to completely clean the particulate-loaded filter assembly and restore clean filtering conditions for the next filtration cycle. The presence of inorganic ash residue may require the use of an air-back pulse to remove the ash for the ceramic fiber filter.

In some example embodiments of the present general inventive concept, a system for removing hydrocarbon and carbon contaminates from a continuous hot gas stream generated from a gas stream source includes a mechanical filter assembly including an intake to receive the gas stream, an outlet to exhaust the gas stream, and a ceramic fiber filtration media interposing the intake and outlet to remove particle and tar contaminates from the gas stream, and a contained filter heating system and reverse air-backpulse to clean the filter assembly.

In some embodiments, the mechanical filter assembly removes particles larger than one micrometer in diameter and tars from the gas stream.

Some embodiments include an auxiliary heat source communicably coupled to the mechanical filter assembly, the heat source selectively exposing the mechanical filter assembly to a temperature range of above 750° F. to clean the mechanical filter assembly.

Some embodiments include a second mechanical filter assembly in fluid communication by directional mechanical valves, the gas stream being selectively directed to the second mechanical filter assembly while the first mechanical system is being cleaned when the heat source is activated.

In some embodiments, the filtration media includes ceramic fibers held together by a ceramic binder.

In some example embodiments of the present general inventive concept, a method of removing hydrocarbon particulates, tars and inorganic ash from a continuous hot gas stream generated by a gas source includes providing a mechanical filter assembly including an intake to receive the gas stream, an outlet to exhaust the gas stream, and a filtration media interposing the intake and outlet to remove particle contaminates from the gas stream, filtering the gas stream with the mechanical filter assembly to remove particle contaminates therefrom as the gas stream flows through the filtration media, and applying a metal catalyst to the ceramic fiber filter media to convert carbon particles and tars to syngas.

In some embodiments, the filtering operation removes particle contaminates larger than one micrometer in diameter from the gas stream.

In some embodiments, the filtering operation occurs before the treating operation.

Some embodiments include the operation of regenerating the mechanical filter assembly.

Some embodiments include communicably coupling an auxiliary heat source to the mechanical filter assembly, interrupting filtration of the gas stream by the mechanical filter assembly, and activating the auxiliary heat source to expose the mechanical filter assembly to a temperature range exceeding 750° F. to clean the mechanical filter assembly and applying an air-backpulse to remove inorganic ash.

Some embodiments include the operation of diverting the gas stream to a second mechanical filter assembly while the first mechanical filter assembly is being cleaned.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1a illustrates a ceramic fiber filter media, in accordance with various example embodiments of the present general inventive concept;

FIG. 1b illustrates an example embodiment pleated ceramic fiber filter cartridge, within which the filter media of FIG. 1a is disposed;

FIG. 2a illustrates a representative diagram of an example embodiment biomass gas power generation system filtering a syngas stream, wherein the system includes a ceramic fiber filter assembly interposing a gasifier and a plasma generation tube;

FIG. 2b illustrates the example embodiment system of FIG. 2a whereby the ceramic fiber filter assembly is regenerated in-situ; and

FIG. 3 illustrates an example embodiment restaurant grease emissions control system including a ceramic fiber filter assembly interposing a restaurant broiler and a thermal regeneration source.

### DETAILED DESCRIPTION

Reference will now be made to various example embodiments of the present general inventive concept, examples of which are illustrated in the accompanying drawings and illustrations. The example embodiments are described herein in order to explain the present general inventive concept by referring to the figures. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

In accordance with various example embodiments of the present general inventive concept, a ceramic fiber system may contain a mechanical filter downstream from a biomass gasifier and upstream from and in fluid communication with a contained plasma cleaning medium or other auxiliary cleaning systems. The mechanical filter assembly may include an intake to receive an incoming gas stream, such as a syngas stream, an outlet to exhaust the gas stream, and filtration media interposing the intake and outlet to remove particulates and tars from the gas stream. In some embodiments, the mechanical filter assembly is a ceramic fiber filter assembly. The contained plasma medium or liquid scrubbers may receive the gas stream from the mechanical filter assembly outlet and treat the gas stream by converting undesirable gaseous contaminates and removing small particle contaminates, or both from the gas stream as it flows through the plasma medium and/or the liquid scrubbers. In some embodiments, the mechanical filter assembly is communicably coupled to an auxiliary heat source to provide a means for regenerating, or cleaning, the mechanical filter assembly in-situ and an air-backpulse to remove inorganic ash.

It will be noted that while the present application generally refers to syngas throughout for convenience, the present general inventive concept is not limited to any particular type of gas stream. Accordingly, other types of gases may be incorporated without departing from the scope or spirit of the present general inventive concept.

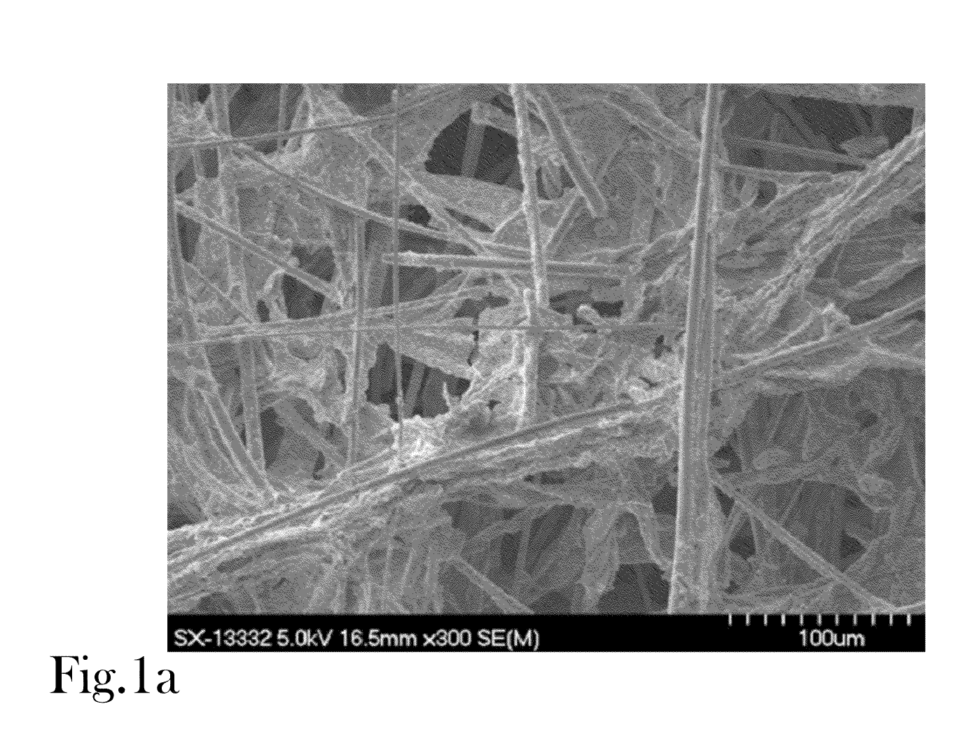

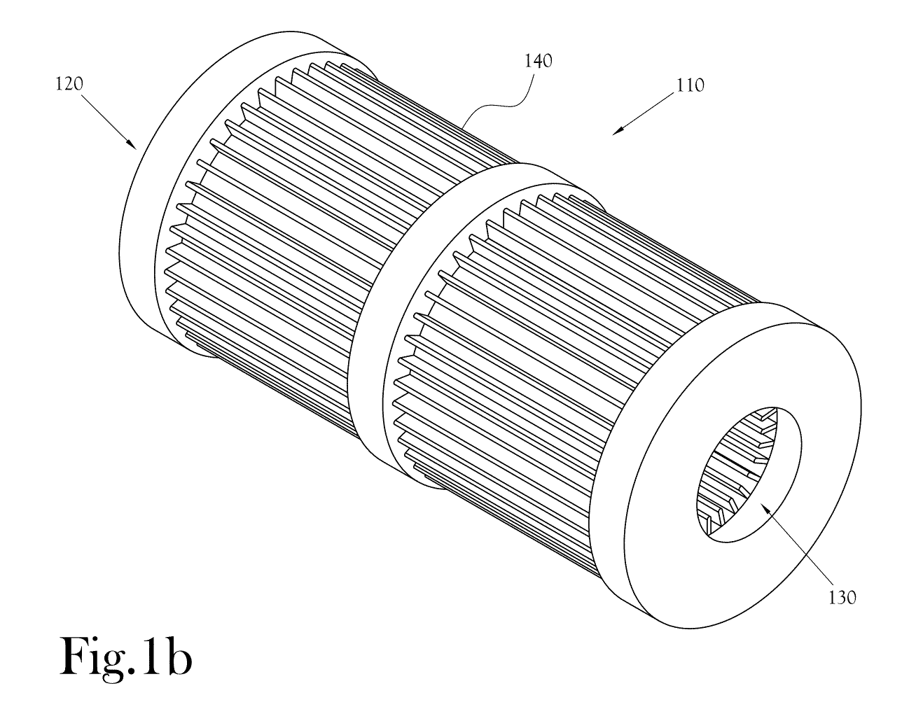

FIGS. 1a and 1b illustrate a ceramic fiber filter, in accordance with various example embodiments of the present general inventive concept. FIG. 1a depicts a ceramic fiber filter media that is disposed within the ceramic fiber filter cartridge depicted in FIG. 1b.

Referring to FIG. 1a, a ceramic fiber filter media may include a web of ceramic fibers held together by a ceramic binder, such as the ceramic fiber-based filter web disclosed in U.S. Pat. No. 6,913,059, the contents of which are incorporated by reference herein. The open porosity of the ceramic fiber-based web, the 2,200° F. operating capability of the ceramic structure, and the low thermal mass of the filter media provide filtration properties and system operation parameters suitable for pre-filtration and in-situ cleaning for filter-plasma treatment systems. More particularly, the open porosity of the fiber web accommodates a low backpressure and low thermal mass of the filter assembly, which are of concern in the present general inventive concept. It will be noted that use of the term “backpressure” herein refers to a pressure differential created between two environments separated by the filter media.

In other embodiments, ceramic/metal candle filters and/or extruded wall-flow filters may be used. However, one of skill in the art will recognize that the filtration properties and system operation parameters of these non-ceramic fiber embodiments may limit pre-filtration efficacy and/or in-situ regenerating capabilities of the ceramic fiber treatment system. These systems require cooling of the gas stream and removal for chemical cleaning in the presence of tars.

Referring to FIG. 1b, the ceramic fiber-based filter web may be disposed within a filter cartridge, such as those manufactured by Industrial Ceramic Solutions, LLC. As illustrated, a pleated web of ceramic fibers provides a highly efficient filtration means without occupying a significant volume of space. Thus, in embodiments using a pleated, ceramic, fiber-based filter web, decreased system weight and volume may be achieved. The presently illustrated example embodiment is advantageous in that the energy required to clean the pleated ceramic-fiber-based web by thermal oxidation is minimal. The filter cartridge depicted in FIG. 1b may be disposed within a containment structure, which may also occupy minimal space.

As illustrated in FIG. 1b, the filter cartridge is an elongated toroidal member 110 with an internal cavity sealed on one end 120. The other end of the internal cavity 130 is open to provide access to the interior of the filter cartridge. The present general inventive concept includes the filtering of contaminated syngas by directing the syngas through the intake of the filter cartridge. Generally, the intake of the filter cartridge is the sides of the toroidal member, where the pleated web of ceramic fibers 140 permits selective permeation therethrough. In some embodiments, the filter cartridge intakes are adapted to permit particles smaller than one micrometer in diameter to permeate therethrough. The outlet of the filter cartridge is the open end 130 of the internal cavity.

In other embodiments utilizing ceramic/metal candle filters and/or extruded wall-flow filters, the weight and volume of the filter assembly may exceed 1000 times that of a ceramic fiber filter. One of skill in the art will also recognize, however, that thermal oxidation cleaning in these other embodiments may be severely limited, if not impossible.

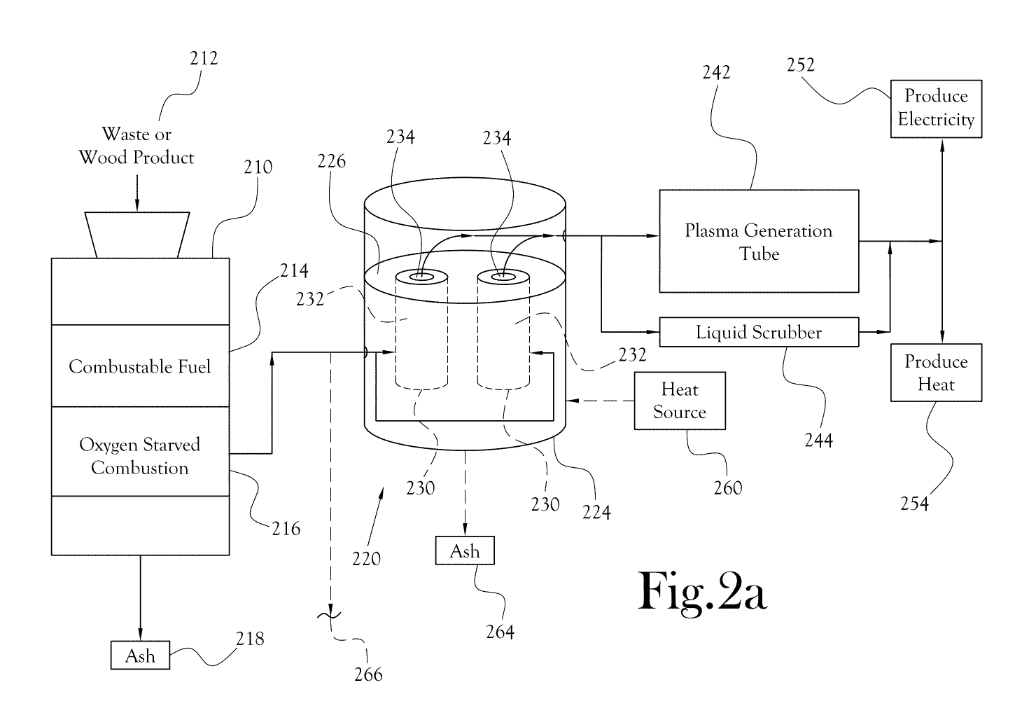

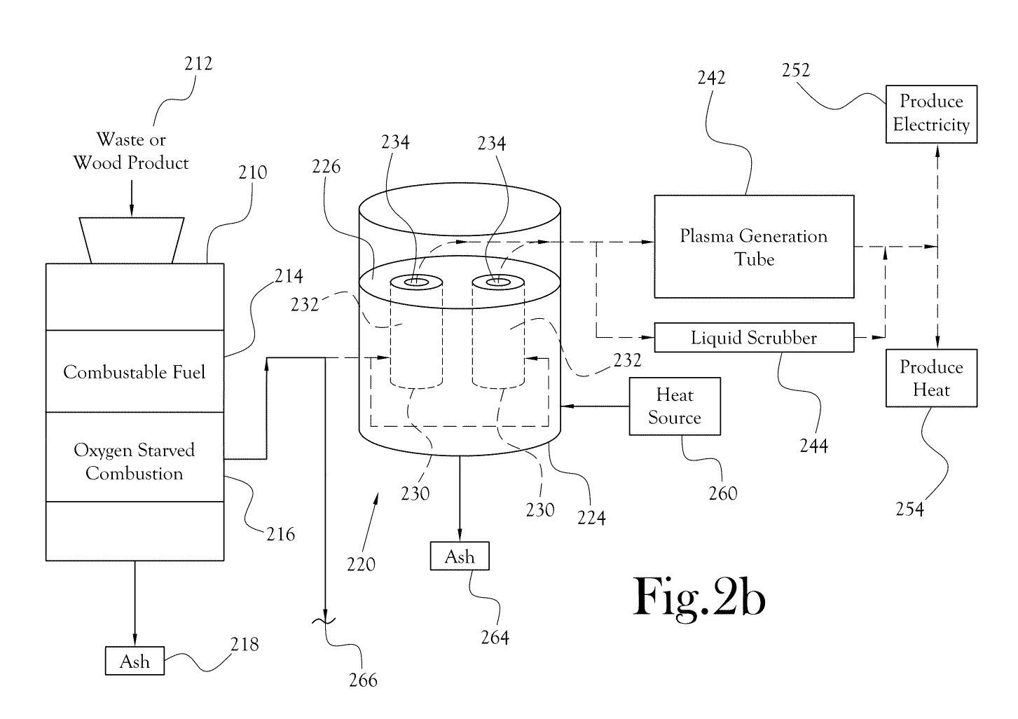

FIG. 2a illustrates a representative diagram of an example embodiment biomass gas power generation system filtering a syngas stream, wherein the system includes a ceramic fiber filter assembly interposing a gasifier and a plasma generation tube.

A gasifier 210 is provided at the far left of FIG. 2a to receive and combust organic waste products 212, such as wood. Using combustible fuel 214, the gasifier 210 in the illustrated example embodiment burns the organic waste products in an oxygen-starved environment 216 to produce syngas. One of skill in the art will recognize that syngas frequently includes, but is not limited to carbon monoxide, hydrogen, and methane. However, organic combustion will also frequently output hydrocarbon contaminates, such as ash, soot, tar, creosote, and unburned organic material. Heavy particulates like ash will frequently separate 218 from the gaseous combustion products during combustion, and may be collected and/or disposed of prior to directing the syngas stream to the remainder of the system.

The contaminated syngas stream produced by the gasifier, or syngas stream source, is directed to a mechanical filter assembly 220. In the illustrated example embodiment, the mechanical filter assembly 220 includes two filter cartridges 230 disposed within a containment structure 224. The containment structure 224 has been adapted to cooperate with the filter cartridges 230 to provide bifurcated filtration zones using a separating plate 226. As illustrated, the filter cartridge intakes 232 are located on the sides of the filter cartridges 230, below the separating plate 226, while the filter cartridge outlets 234, or the open ends, are located at or above the separating plate 226. One of skill in the art will recognize that the separating plate 226 and filter cartridge outlets 234 may be coupled using conventional techniques to provide for a sealed separation of filtration zones. Thus, the zone below the separating plate 226 and outside of the filter cartridges 230 is an unfiltered zone, whereas the zone above the separating plate 226 and inside the filter cartridges 230 is a filtered zone.

Still referring to FIG. 2a, the contaminated syngas stream is mechanically filtered by traveling into the filter cartridge containment structure 224, through the filter cartridge intakes 232, and out of the filter cartridge outlets 234. Particulate contaminates, namely large particulates over one micrometer in diameter, as well as tars, are removed from the syngas stream by the mechanical filter assembly 220.

After being exhausted through the filter cartridge outlets 234, the syngas stream is then directed through a contained plasma medium, such as a plasma generation tube 242, or through a system of liquid scrubbers 244. Numerous means of producing a plasma medium are known in the art. For instance, a plasma generating means may include a plurality of conducting rods, wires, or plates provided with an electrical current. One of skill in the art will recognize that the present general inventive concept is not limited to any particular plasma generating means. It is contemplated that a plasma medium may be generated through any means known in the art, including but not limited to heat, electrical field initiation, and/or electromagnetic field initiation. One of skill in the art will also recognize that a number of liquid scrubbers are compatible with the present general inventive concept.

Still referring to FIG. 2a, as the syngas stream flows through the plasma generation tube 242 or liquid scrubbers 244, small particle contaminates still contained within the gas stream, such as those smaller than one micrometer in diameter, are removed, as are gaseous contaminates. One of skill in the art will recognize that the active species contained within the plasma medium (e.g., metastables, atomic species, free radicals, and ions) chemically and/or physically modify the syngas stream to achieve the removal of hydrocarbon contaminates. The uncontaminated syngas stream exits the plasma generation tube, where it may then be harvested and further combusted to produce electricity 252 and/or heat 254.

FIG. 2b illustrates the example embodiment system of FIG. 2a whereby the ceramic fiber filter assembly is being cleaned in-situ using an auxiliary heat source 260 that has been communicably coupled to the mechanical filter assembly 220. Any inorganic ash that remains on the filter cartridges 230 after thermal cleaning may be removed by an air-backpulse through the ceramic fiber filter.

Referring to FIG. 2b, the heat source 260 communicably coupled to the mechanical filter assembly 220 has been activated for mechanical filter regeneration. The auxiliary heat source 260 may be coupled to the mechanical filter assembly 220 using valves to selectively control heat exposure. Just prior to mechanical filter regeneration, combustible syngas is purged from the assembly using air, and the intake of the syngas stream from the gasifier 210 or other syngas source is selectively interrupted and, in many cases, diverted 266.

When all of the syngas has been removed, the filter cartridges 230 are heated to temperatures in excess of 750° F., preferably to a range of 1,000° F. to 1,200° F. by electrical or gas heated air influx until the filter cartridges 230 are cleaned of accumulated organic or carbonaceous particle contaminates. Inorganic ash is removed 264 by a high-pressure air-backpulse in reverse of the normal flow through the ceramic fiber filter. Those of skill in the art will recognize that the mechanical filter regenerating means discussed and illustrated herein will have limited applicability in embodiments utilizing non-ceramic fiber based mechanical filter assemblies.

Heat exposure generally lasts between one and three hours to achieve effective mechanical filter regeneration. One of skill in the art will recognize that carbon and hydrocarbon contaminates are cleaned from the filter assembly by the oxidation of the contaminates into carbon dioxide and water. After heat exposure, the cleaned filter cartridges 230 may then be exposed to a high-pressure gas purge to remove any remaining mineral ash 264, which typically drops out of the bottom of the mechanical filter assembly 220. The cleaned cartridges 230 and cleaned mechanical filter assembly 220 may then be prepared to resume operation.

In some embodiments, the need for mechanical filter regeneration is correlatable to the instantaneous backpressure of the filter assembly. Filter assembly back pressure may be monitored using a differential pressure gauges measuring both sides of the separating plate. Those of skill in the art will recognize that backpressure levels indicative of a need for mechanical filter regeneration will vary by application.

In some embodiments, the intake of the syngas stream into the mechanical filter assembly is interrupted by the redirection of the syngas stream to a second mechanical filter assembly, illustrated by the vertically downward phantom arrow in FIG. 2a, and the vertically downward solid arrow in FIG. 2b. In order to maintain continuous generation of uncontaminated syngas, the system must have a secondary mechanical filter assembly to accommodate the gas stream during regeneration of the original filter assembly.

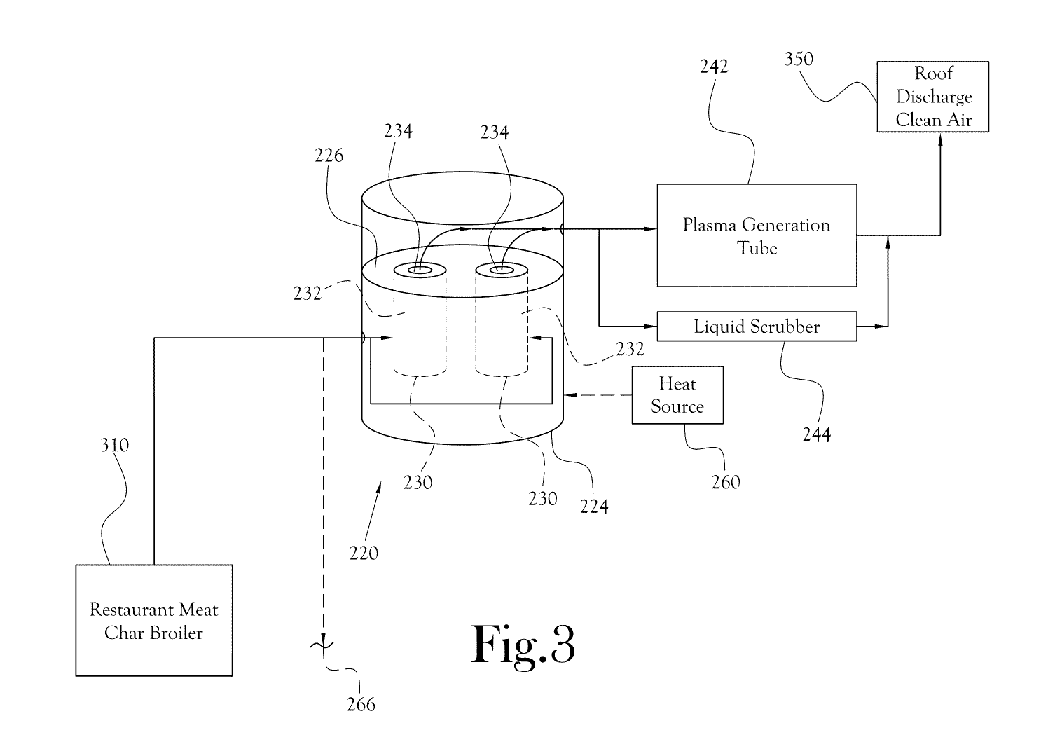

FIG. 3 illustrates an example embodiment restaurant grease emissions control system including a ceramic fiber filter assembly interposing a restaurant or commercial cooking hazardous effluent source. A grease emission source 310 in the illustrated example embodiment serves the role of the gasifier 210 in FIGS. 2a and 2b, by providing a syngas stream source through the combustion of organic materials. However, unlike the previously illustrated example embodiments, the uncontaminated syngas is discharged into the atmosphere 350. Thus, the present general inventive concept may also provide for an environmentally friendly effluent system.

One of skill in the art will recognize that numerous applications exist for the present general inventive concept. In addition to those discussed and illustrated herein, it is contemplated that the present general inventive concept may be applied to diesel vehicle exhausts, industrial exhaust emissions, chemical and petrochemical emissions, and all forms of energy production. One of skill in the art will also recognize that the backpressure levels necessitating mechanical filter regeneration will vary by application. Further, in some embodiments, the mechanical filter is optionally pressurized (such as between 2-5 psi) as called for by application-specific operating variables.

In some example embodiments of the present general inventive concept, a system for removing hydrocarbon and carbon contaminates from a continuous hot gas stream generated from a gas stream source includes a mechanical filter assembly including an intake to receive the gas stream, an outlet to exhaust the gas stream, and a ceramic fiber filtration media interposing the intake and outlet to remove particle and tar contaminates from the gas stream, and a contained filter heating system and reverse air-backpulse to clean the filter assembly.

In some embodiments, the mechanical filter assembly removes particles larger than one micrometer in diameter and tars from the gas stream.

Some embodiments include an auxiliary heat source communicably coupled to the mechanical filter assembly, the heat source selectively exposing the mechanical filter assembly to a temperature range of above 750° F. to clean the mechanical filter assembly.

Some embodiments include a second mechanical filter assembly in fluid communication by directional mechanical valves, the gas stream being selectively directed to the second mechanical filter assembly while the first mechanical system is being cleaned when the heat source is activated.

In some embodiments, the filtration media includes ceramic fibers held together by a ceramic binder.

Some embodiments include a polishing filter located downstream of the plasma generation tube or liquid scrubber.

In some example embodiments of the present general inventive concept, a method of removing hydrocarbon particulates, tars and inorganic ash from a continuous hot gas stream generated by a gas source includes providing a mechanical filter assembly including an intake to receive the gas stream, an outlet to exhaust the gas stream, and a filtration media interposing the intake and outlet to remove particle contaminates from the gas stream, filtering the gas stream with the mechanical filter assembly to remove particle contaminates therefrom as the gas stream flows through the filtration media, and applying a metal catalyst to the ceramic fiber filter media to convert carbon particles and tars to syngas.

In some embodiments, the filtering operation removes particle contaminates larger than one micrometer in diameter from the gas stream.

In some embodiments, the filtering operation occurs before the treating operation.

Some embodiments include the operation of regenerating the mechanical filter assembly.

Some embodiments include communicably coupling an auxiliary heat source to the mechanical filter assembly, interrupting filtration of the gas stream by the mechanical filter assembly, and activating the auxiliary heat source to expose the mechanical filter assembly to a temperature range exceeding 750° F. to clean the mechanical filter assembly and applying an air-backpulse to remove inorganic ash.

Some embodiments include the operation of diverting the gas stream to a second mechanical filter assembly while the first mechanical filter assembly is being cleaned.

Various example embodiments of the present general inventive concept allow for filtering contaminants from a hot syngas stream. In internal combustion turbine generators known in the prior art, the syngas typically must be cooled before filtering; then, after filtering, the syngas must be heated again immediately before the syngas is combusted in order for generator to operate most efficiently. This requirement to cool and then reheat the syngas reduces the net energy productivity of the syngas fuel. By facilitating the filtering of contaminants from a hot syngas stream directly from a gasifier or other syngas source, without cooling, various example embodiments of the present general inventive concept can approximately double the fuel efficiency of syngas-fueled internal combustion turbine generator systems.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

While the present general inventive concept has been illustrated by description of several example embodiments, it is not the intention of the applicant to restrict or in any way limit the scope of the inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings.

1. A system for removing hydrocarbon and carbon contaminates from a continuous hot gas stream generated from a gas stream source, said system comprising:
a mechanical filter assembly including an intake to receive the gas stream, an outlet to exhaust the gas stream, and a ceramic fiber filtration media interposing the intake and outlet to remove particle and tar contaminates from the gas stream; and
a contained filter heating system and reverse air-backpulse to clean the filter assembly.

2. The system of claim 1, wherein the mechanical filter assembly removes particles larger than one micrometer in diameter and tars from the gas stream.

3. The system of claim 1, further comprising an auxiliary heat source communicably coupled to the mechanical filter assembly, the heat source selectively exposing the mechanical filter assembly to a temperature range of above 750° F. to clean the mechanical filter assembly.

4. The system of claim 3, further comprising a second mechanical filter assembly in fluid communication by directional mechanical valves, the gas stream being selectively directed to the second mechanical filter assembly while the first mechanical system is being cleaned when the heat source is activated.

5. The system of claim 1, wherein the filtration media includes ceramic fibers held together by a ceramic binder.

6. A method of removing hydrocarbon particulates, tars and inorganic ash from a continuous gas stream generated by a gas source, said method comprising:
providing a mechanical filter assembly including an intake to receive the gas stream, an outlet to exhaust the gas stream, and a filtration media interposing the intake and outlet to remove particle contaminates from the gas stream;
filtering the gas stream with the mechanical filter assembly to remove particle contaminates therefrom as the gas stream flows through the filtration media; and
applying a metal catalyst to the ceramic fiber filter media to convert carbon particles and tars to syngas.

7. The method of claim 6, wherein the filtering operation removes particle contaminates larger than one micrometer in diameter from the gas stream.

8. The method of claim 6, wherein the filtering operation occurs before the treating operation.

9. The method of claim 6, further comprising the operation of regenerating the mechanical filter assembly.

10. The method of claim 9, wherein the regenerating operation comprises:
communicably coupling an auxiliary heat source to the mechanical filter assembly;
interrupting filtration of the gas stream by the mechanical filter assembly; and
activating the auxiliary heat source to expose the mechanical filter assembly to a temperature range exceeding 750° F. to clean the mechanical filter assembly and applying an air-backpulse to remove inorganic ash.

11. The method of claim 10, further comprising the operation of diverting the gas stream to a second mechanical filter assembly while the first mechanical filter assembly is being cleaned.
